(19) United States
(12) Patent Application Publication
(10) Pub. No.: US 2026/0187258 A1
(43) Pub. Date: Jul. 2, 2026

(54) FIRE PANEL LOG MANAGEMENT SYSTEM WITH ENVIRONMENTAL DATA INTEGRATION, AND RELATED METHODS

(71) Applicant: Mark Mieila, Edmonton (CA)

(72) Inventor: Mark Mieila, Edmonton (CA)

(21) Appl. No.: 19/437,258

(22) Filed: Dec. 30, 2025

(30) Foreign Application Priority Data
Dec. 30, 2024 (CA) 3260995

(51) Int. Cl. G06F 21/60; G06F 16/335; G06F 40/205

(52) U.S. Cl. CPC G06F 21/604; G06F 16/335; G06F 40/205; G06F 2221/2145

(57) ABSTRACT

A fire panel log management system has a custom-made local computing device externally connected to the panel via an accessible port such as an RS232 printer port. The device captures binary encoded text logs, converts them into a standardized text format, and transmits to cloud-based data buckets. The device exchanges data with a remote computing device, or server, using an application layer communication protocol such as MQTT or HTTP, along with cryptographic communication protocol such as TLS/SSL to ensure secure communication. Real-time environmental data is collected such as weather, temperature, humidity, and solar radiation, including local temperature, humidity and air pressure. A web-based application provides a dashboard for visualizing logs, environmental data, and device status. Advanced log filtering by time and keywords, historical data review, with multi-tier user access control (Admin, Dealer, and Manager). The system is scalable and adaptable across various fire safety systems.

### FIELD OF INVENTION

This document relates to fire panel log management systems with environmental data integration, and related methods.

### BACKGROUND

The following paragraphs are not an admission that anything discussed in them is prior art or part of the knowledge of persons skilled in the art.

Fire safety systems are critical for the protection of buildings and occupants. Traditional fire panel systems generate logs that record events and statuses related to fire alarms, security, and safety measures. However, the management, monitoring, and visualization of these logs can be challenging, especially in large organizations with multiple buildings and hierarchical user roles. Existing solutions often lack comprehensive data visualization, filtering for specific events, environmental data integration to predict instrumentation failure, and robust user access controls, limiting effectiveness in real-time monitoring and historical analysis.

### SUMMARY OF THE INVENTION

A fire panel gateway system is disclosed comprising: a data acquisition module that: is connectable to receive fire panel data from a fire panel; and has or is connected to a network interface that is configured to transmit output data from the data acquisition module to a remote computing device via the internet, the output data comprising time-coded log information from the fire panel data, for external storage of the output data, in association with environmental condition data, in a database.

A fire panel gateway system is disclosed comprising: a remote computing device; a data acquisition module that: is connectable to receive fire panel data from a fire panel; and has or is connected to a network interface that is configured to transmit output data from the data acquisition module to the remote computing device via the internet, the output data comprising time-coded log information from the fire panel data; and in which the remote computing device has, or is connected to store the output data, in association with environmental condition data, in a cloud database.

A fire panel gateway system is disclosed comprising: a data acquisition module that: is connectable to receive fire panel data from a fire panel; has or is connected to one or more sensors that are configured to record environmental condition data; and has or is connectable to a network interface that is configured to transmit output data from the data acquisition module to a remote computing device via the internet, the output data comprising time-coded information from the fire panel data and the environmental condition data.

A method comprises using the fire panel gateway system to receive and store output data from the fire panel in the database.

A method comprises serving output data from the database to a remote device of a user.

A web-based fire panel log management system is disclosed comprising: a local computing device, such as a microcontroller device, configured to establish a physical connection with a fire panel's printer port via an RS232 serial communication interface; a data acquisition module operatively connected to the local computing device, wherein the data acquisition module is configured to capture binary encoded text data, such as ASCII or UTF-8 format, output from the fire panel through the fire panel RS232 interface (or other suitable interface such as USB, RS485, and ethernet interfaces, and convert said binary encoded text data into a standardized text format; a communication interface integrated with the local computing device, configured to transmit the standardized text format data to a cloud database, such as PostgreSQL™, utilizing an application layer communication protocol such as MQTT or HTTP; a cloud-based storage unit hosted on a cloud platform for receiving and storing the transmitted standardized text data; a web-based application interface operatively connected to the cloud-based storage unit, the web-based application comprising: a dashboard module configured to display real-time and historical data, including device information and environmental conditions comprising weather data, interior and exterior temperature and humidity levels, and solar radiation metrics; a log filtering module enabling users to filter captured logs based on specified time ranges and keyword inputs; a historical data visualization module allowing users to access and review archived logs; a multi-tier user access control mechanism incorporated within the web-based application, the access control mechanism comprises: an Admin tier authorized to add and manage organizations and dealers within the system; a Dealer tier authorized to add main users, organizations, and sub-organizations under their purview; a Manager tier is authorized to assign and manage users within specific sub-organizations, thereby restricting user access to logs pertinent exclusively to designated buildings within said sub-organizations.

A fire panel monitoring and environmental management system is disclosed comprising: a local computing device connected to the fire panel's printer port using RS232 to capture binary encoded text log data from the fire panel; a modular sensor interface integrated into the system, enabling the addition of multiple environmental sensors, including but not limited to temperature, humidity, and solar radiation sensors, for real-time data collection and monitoring; a communication module that transmits both fire panel log data and environmental sensor data to a cloud-based platform using as PostgreSQL, utilizing an application layer communication protocol such as MQTT or HTTP; a web-based dashboard allowing users to view, analyze, and correlate fire panel logs with environmental data to enhance building safety and environmental awareness; an alert system integrated with the modular sensors, triggering notifications when environmental thresholds are exceeded or when specific fire panel events occur.

A system is disclosed for managing fire panel data and environmental monitoring, comprising: a local computing device interfaced with a fire panel's printer port using RS232communication to capture binary encoded text logs generated by the fire panel; a data conversion module that converts the captured binary encoded text into a text format; a communication module that transmits the text format data to a cloud-based data bucket using as PostgreSQL, utilizing an application layer communication protocol such as MQTT or HTTP; a web-based application that interfaces with the cloud data bucket to display real-time fire panel logs, device information, and environmental data, including weather conditions, interior/exterior temperature, humidity, and solar radiation; a filtering system integrated into the web application allows users to filter the fire panel logs by time range and keywords; a hierarchical user access control system that restricts access to different functionalities based on user roles, wherein the system comprises an Admin role to manage organizations and dealers, a Dealer role to manage sub-organizations and users, and a Manager role to manage building-level access for technicians and handymen.

A method is disclosed for enhanced fire panel log management and reporting, comprising the steps of: acquiring binary encoded text log data from a fire panel via a local computing device connected through an RS232 interface; storing and organizing the log data in a cloud-based data bucket using as PostgreSQL, utilizing an application layer communication protocol such as MQTT or HTTP; providing a data analytics engine in a web application to generate customized reports for users based on log filtering, event correlation, and environmental factors; enabling users to schedule automatic report generation and delivery, where the report includes key fire panel events, environmental data, and alerts for critical conditions.

A system is disclosed for managing fire panel data with customizable workflows for fire safety personnel, comprising: a local computing device that connects to the fire panel's printer port using RS232, capturing binary encoded text data and transmitting it via utilizing an application layer communication protocol such as MQTT or HTTP to a cloud-based storage system; a web application that provides role-based access for users, including Admin, Dealer, and Manager roles; a customizable workflow engine that allows Admin users to define workflows for fire safety personnel, including automatic task assignments based on fire panel events, environmental conditions, and user roles, improving response time and efficiency in fire alarm management; a notification system that integrates with the customizable workflows to provide real-time alerts and instructions to relevant personnel based on predefined conditions.

A system is disclosed for fire panel monitoring and risk analysis, comprising: a local computing device connected to a fire panel's printer port via RS232, capturing binary encoded text log data and transmitting it to a cloud-based platform utilizing an application layer communication protocol such as MQTT or HTTP; a machine learning engine integrated into the system to analyze historical fire panel logs and environmental data for patterns indicative of potential fire safety risks; an AI-powered alert system that generates early warnings to users based on predictive models, alerting them to take preventive actions before a critical event occurs; a user interface in the web application that provides risk analysis insights, including visual displays of potential risks based on historical trends and real-time data.

A system is disclosed for fire panel log management that includes an incident replay feature, comprising: a local computing device interfaced with a fire panel via RS232 for data capture; a cloud-based platform for storing and analyzing fire panel logs and environmental data; an incident replay feature in the web application that allows users to replay the sequence of events leading up to a fire alarm or other critical event, by visualizing both fire panel logs and environmental data in a synchronized timeline view, aiding in post-incident analysis and reporting.

A system is disclosed for remote fire panel log monitoring and maintenance, comprising: a local computing device connected to a fire panel via RS232 to capture log data and transmit it utilizing an application layer communication protocol such as MQTT or HTTP to a cloud platform; a web application providing real-time remote access to fire panel logs for maintenance personnel; a remote diagnostic module within the web application that allows authorized users to perform remote diagnostics, detect potential issues, and schedule maintenance tasks based on fire panel performance and log data; a maintenance alert system that notifies personnel of upcoming scheduled maintenance and highlights potential issues based on fire panel logs and environmental data.

A system is disclosed for fire panel monitoring that integrates with smart building management systems, comprising: a local computing device that captures fire panel data via RS232 and transmits it utilizing an application layer communication protocol such as MQTT or HTTP to a cloud-based platform; a smart building integration module that allows the fire panel log data to be shared with the building's smart systems, such as Heating, Ventilation, and Cooling (HVAC) and lighting systems, enabling coordinated responses to fire events (e.g., turning off HVAC systems during a fire alarm); a web application providing a centralized interface for both fire panel logs and smart building system responses, enabling streamlined management of building safety operations.

A method is disclosed for synchronizing real-time fire panel log data and environmental conditions across multiple user devices, comprising: acquiring log data from a fire panel using a local computing device connected via RS232, transmitting the data utilizing an application layer communication protocol such as MQTT or HTTP to a cloud-based platform; acquiring environmental data from integrated sensors for temperature, humidity, and solar radiation; synchronizing both fire panel logs and environmental data across multiple user devices via a real-time web application using WebSocket technology to ensure all users have up-to-date information for critical decision-making; enabling real-time collaboration between users through shared views, annotations, and alert notifications within the application interface.

In various embodiments, there may be included any one or more of the following features: The remote computing device connected to receive the output data through the internet via the network interface; and in which the remote computing device has, or is connected to store the output data, in association with environmental condition data, in the database. The remote computing device is configured to obtain at least a portion of the environmental condition data from one or more third party sources. The remote computing device is configured to obtain at least a portion of the environmental condition data from one or more third party sources via an application programming interface (API). The remote computing device is configured to obtain at least a portion of the environmental condition data via the application programming interface (API) by automatically polling the API at periodic intervals. The remote computing device is configured to serve instructions to load an application interface on a remote computer or mobile device, the application interface configured to display at least part of the data from the database. The application interface is configured to include or access a filtering system that allows users to filter the data from the database by time range and keywords. The remote computing device is configured to incorporate a hierarchical user access control methodology that restricts user access to different functionalities and data from the database based on user roles. The user roles comprise one or more of: an administrator role to manage organizations and dealers; a dealer role to manage sub-organizations and users; and a manager role to manage building-level access for technicians. The application interface is configured to display data from the database in a multi-tenant architecture form, to enable a plurality of organizations to access data from the database, comprising fire panel logs and environmental condition data, independently while sharing the same underlying infrastructure, and where each organization has independent control over user access within their domain. The remote computing device is configured to operate a real-time alert system module, which sends notifications to users based on predefined events from the database. The remote computing device is configured to operate a machine learning module that analyzes the data from the database over time to predict potential fire safety risks based on historical patterns and environmental conditions. The data acquisition module has or is connected to one or more sensors that are configured to record at least a portion of the environmental condition data; and the data acquisition module is configured to include, within the output data, the environmental condition data from the one or more sensors. The one or more sensors and the network interface are integrated on board the data acquisition module. The environmental condition data comprises one or more of weather conditions, air pressure, interior temperature, exterior temperature, humidity, and solar radiation activity. The solar radiation activity comprises one or more of coronal mass ejection, geomagnetic storm, and solar flare information specific to the location of the data acquisition module or fire panel. The data acquisition module is configured to include in the output data, for external storage in the database, of one or more of fire panel auxiliary voltage, fire panel auxiliary current, and data acquisition module power consumption. The data acquisition module comprises a system-on-chip microcontroller, that is configured to establish a physical connection with a communication interface of the fire panel. The data acquisition module is configured to: capture raw byte data output from the fire panel through the communication interface; parse the raw byte data according to the fire panel's specific protocol specification; convert the parsed data into standardized text format data; and include the standardized text format data within the output data for external storage in the database. The data acquisition module is configured to operate as a universal device that is configured to connect to a variety of makes and models of fire panels. The network interface is configured to communicate the output data via a higher-level application layer. The remote computing device further comprises a report-generation module configured to: automatically parse, classify, and map the output data to corresponding inspection and testing requirements defined in national fire-alarm reporting standards; populate standardized inspection and testing forms mandated by the applicable national fire-alarm reporting standard, including required fields relating to device functionality, emergency power performance, wiring integrity, communication pathways, system supervisory conditions, and overall system operation; and generate a compliant inspection or testing report in a structured electronic format suitable for submission to building owners, authorities having jurisdiction, or service providers. The data acquisition module is configured to capture binary encoded text data output from the fire panel through the RS-232 serial communication interface 124 and convert the binary encoded text data into a standardized text format, which is included within the output data. The data acquisition module is configured to operate as a universal device that may be configured to connect to a variety of fire panel makes and models. The network interface is configured to communicate the output data via an MQTT (Message Queuing Telemetry Transport) messaging protocol. The data acquisition module has or is connected to one or more sensors that are configured to record at least a portion of the environmental condition data; and the data acquisition module is configured to include within the output data time-coded information from the fire panel data and the environmental condition data from the one or more sensors. The remote computing device is configured to obtain at least a portion of the environmental condition data from one or more third party sources. The remote computing device is configured to obtain at least a portion of the environmental condition data from one or more third party sources via an API (Application Programming Interface). The remote computing device is configured to obtain at least a portion of the environmental condition data via the API by automatically polling the API at periodic intervals. The environmental condition data comprises one or more of weather conditions, interior temperature, exterior temperature, humidity, and solar radiation activity. The solar radiation activity comprises one or more of:
coronal mass ejection, geomagnetic storm, and solar flare information specific to the location of the data acquisition module or fire panel. The data acquisition module comprises a system-on-chip microcontroller that is configured to establish a physical connection with a printer port of the fire panel. The local computing device is configured to connect to the printer port via an RS-232 (Recommended Standard 232) serial communication interface. The data acquisition module is configured to capture binary encoded text data output from the fire panel through the RS-232 interface and convert the binary encoded text data into a standardized text format, which forms the output data. The remote computing device is connected to receive the output data through the internet via the network interface. The remote computing device has or is connected to store and retrieve the output data to and from a cloud database. The data acquisition module comprises a system-on-chip microcontroller that is configured to establish a physical connection with a printer port of the fire panel. The local computing device is configured to connect to the printer port via an RS-232 (Recommended Standard 232) serial communication interface. The data acquisition module is configured to capture binary encoded text data output from the fire panel through the RS-232 interface and convert the binary encoded text data into a standardized text format, which forms the output data. The remote computing device is connected to receive the output data through the internet via the network interface. The remote computing device has or is connected to store and retrieve the output data to and from, a time-series database. The remote computing device is configured to serve instructions to load a web application interface on a remote computer or mobile device, whereby the web application interface is configured to display at least part of the output data. The web application interface is configured to include or access a filtering system that allows users to filter the output data by time range and keywords. The remote computing device is configured to incorporate a hierarchical user access control methodology that restricts user access to different functionalities based on user roles. The user roles comprise one or more of: an administrator role to manage organizations and dealers; a dealer role to manage sub-organizations and users; and a manager role to manage building-level access for technicians and handymen. The web application interface is configured to display output data in a multi-tenant architecture form, to enable a plurality of organizations to access output data, comprising fire panel logs and environmental data, independently while sharing the same underlying infrastructure, and where each organization has independent control over user access within their domain. The remote computing device is configured to operate a real-time alert system module, which sends notifications to users based on predefined events from the output data. The remote computing device is configured to operate a machine learning module that analyzes the output data over time to predict potential fire safety risks based on historical patterns and environmental conditions. The environmental condition data comprises one or more of weather conditions, interior temperature, exterior temperature, humidity, and solar radiation activity. The data acquisition module is a universal device configured to connect to a variety of makes of fire panels. The network interface is configured to communicate the output data utilizing an application layer communication protocol such as MQTT or HTTP messaging protocol. The Local computing device is further configured to interface with fire panels that use BACnet/IP networks for data acquisition, allowing for universal connectivity to fire panels without a printer port. The Local computing device is further configured to preprocess the captured binary encoded text data by performing data validation and error-checking procedures prior to transmission to enhance data integrity and reliability. An application layer communication protocol such as MQTT is implemented to facilitate secure, low-latency, and bi-directional communication between the Local computing device and a cloud platform, ensuring efficient real-time data transmission. The dashboard module includes graphical visualization tools such as time-series graphs, heat maps, and scatter plots to represent environmental data trends and fire panel log activities over specified periods. An authentication module that employs multi-factor authentication (MFA) protocols to verify user identities and enforce role-based access controls within the multi-tier user access control mechanism. The web-based application interface is accessible via standard web browsers on multiple device types, including desktops, tablets, and smartphones, ensuring cross-platform compatibility and accessibility. The web application provides real-time updates of fire panel logs and environmental data, allowing for continuous monitoring. A method for managing fire panel logs using the system, comprising the steps of: Establishing a physical RS232 serial connection or BACnet/IP network connection between a local computing device and a fire panel; capturing and converting log data generated by the fire panel into a standardized text format via the data acquisition module; transmitting the standardized text data to cloud databases, such as PostgreSQL, utilizing the utilizing an application layer communication protocol such as MQTT or HTTP; storing the transmitted data in the cloud-based storage unit hosted on a cloud platform; accessing the stored data through a web-based application interface to display real-time and historical logs, device information, and environmental conditions; filtering the displayed logs based on user-specified time ranges and keywords; managing user access through a multi-tier user access control mechanism to restrict data visibility and interaction based on user roles. Preprocessing the captured binary encoded text data by validating data formats and performing error-checking procedures before transmission to enhance data accuracy and reliability. The step of transmitting the standardized text format data via an application layer communication protocol such as MQTT or HTTP includes using a cryptographic communication protocol such as TLS/SSL to encrypt the data to ensure secure communication between the Local computing device and the cloud platform. The web-based application's dashboard module presents environmental data through interactive graphical visualization tools, enabling users to analyze trends and correlations between environmental conditions and fire panel log activities. Implementing multi-factor authentication (MFA) protocols within the user authentication process to enhance security and enforce role-based access controls. The web-based application interface is optimized for responsiveness and accessibility across various device types, including desktops, tablets, and smartphones. The environmental data displayed includes real-time and/or near real-time metrics related to interior and exterior temperature, humidity, and solar radiation, is captured via sensors integrated with the web application and displayed alongside fire panel logs for comprehensive monitoring of building safety conditions. A user interface that provides customizable views for users based on their access level, allowing each user to view relevant fire panel logs and environmental data corresponding to their organization or sub-organization, and providing alert notifications when specific conditions are met (e.g., temperature thresholds or critical fire panel events). The data transmission between the local computing device and the cloud-based data bucket uses end-to-end encryption via a cryptographic communication protocol such as TLS/SSL along with an application layer protocol such as MQTT or HTTP, to ensure reliable and secure transmission of fire panel logs and environmental data. The fire panel log data is stored in the cloud data bucket with timestamps, allowing users to retrieve and view historical logs and correlate the logs with past environmental conditions to assist in diagnosing fire panel events or building conditions over time. The web application is designed using a multi-tenant architecture, enabling different organizations to manage their own fire panel logs and environmental data separately while sharing the same underlying infrastructure, and where each organization has independent control over user access within their domain. A real-time alert system that sends notifications to users based on predefined events from the fire panel logs or environmental data, including notifications for critical temperature changes, humidity fluctuations, or specific fire panel error codes. The local computing device may include an offline data storage capability, such that if internet connectivity is lost, the captured fire panel log data is stored locally on the local computing device and transmitted to the cloud data bucket once connectivity is restored. A machine learning module that analyzes the fire panel logs and environmental data over time to predict potential fire safety risks based on historical patterns and environmental conditions, providing predictive insights to users through the web application. The communication module supports multiple data transmission protocols, including but not limited to MQTT, HTTP, and WebSocket, allowing flexible integration with a variety of cloud platforms and ensuring reliable data transmission under different network conditions. Correlating environmental sensor data (e.g., temperature, humidity, solar radiation) with fire panel logs to identify potential causative factors for fire panel events and providing predictive warnings to users based on the correlations identified. The web application includes interactive data visualization tools that allow users to dynamically explore fire panel logs and environmental data through graphs, heatmaps, and timeline views, providing insights into historical and real-time events affecting building safety. The customizable workflow engine includes an audit trail feature that logs all actions taken within the system, including tasks assigned, alerts triggered, and actions completed, allowing for complete traceability and compliance with safety regulations. The system includes redundant data storage mechanisms, both locally on the local computing device and in the cloud, to prevent data loss in case of network outages or device failures, ensuring complete log history is maintained. The machine learning engine uses adaptive risk models that continuously improve based on user feedback and additional data inputs, refining the accuracy of fire safety risk predictions over time. A feature that allows users to compare fire safety risks across multiple buildings or sub-organizations within the web application, providing insights into which locations may need more attention based on log data and environmental factors. The incident replay feature includes forensic analysis tools that allow users to mark key events, generate reports on the sequence of events, and identify potential causes based on the correlation between fire panel logs and environmental conditions. The replayed incident data can be exported as a report, enabling detailed post-event reviews and sharing with third-party inspectors or safety authorities. The remote diagnostic module uses predictive maintenance algorithms to forecast when fire panel components are likely to fail, based on analysis of historical log data and current environmental conditions, providing early alerts to schedule preemptive maintenance. The smart building integration module includes automated coordination of fire safety responses, such as locking down areas of the building, disabling elevators, and controlling HVAC systems in response to specific fire panel events. An emergency evacuation coordination module that integrates fire panel data with smart building systems to guide occupants toward safe exits, dynamically updating evacuation routes based on fire panel logs and real-time environmental conditions.

The foregoing summary is not intended to summarize each potential embodiment or every aspect of the subject matter of the present disclosure. These and other aspects of the device and method are set out in the claims.

### BRIEF DESCRIPTION OF DRAWINGS

Embodiments will now be described with reference to the figures, in which like reference characters denote like elements, by way of example, and in which:

FIG. 1 is a schematic view illustrating a fire panel gateway system with a fire panel, a local computing device, cloud storage, and a web application.

FIG. 2 is a schematic view of a fire panel gateway system, with a data acquisition module connected to a fire panel and cloud server, illustrating the interactions between the fire panel, cloud storage and web application of FIG. 1.

FIG. 3 is a schematic view illustrating the deployment of the fire panel gateway system of FIG. 1.

FIG. 4 is a schematic view illustrating the flow of information through the hardware of the fire panel gateway system of FIG. 1 and into the cloud components.

FIGS. 5A-5C are schematic views of a table relationship diagram of a user access database developed for the fire panel gateway system of FIG. 1.

FIG. 6 is a schematic view illustrating a sequence of events involved in the operation of the fire panel gateway system of FIG. 1.

FIG. 7 is a schematic view illustrating a user access hierarchy of the fire panel gateway system of FIG. 1.

FIG. 8 is a schematic view illustrating a security layer and authentication sub-method used with the fire panel gateway system of FIG. 1.

### DETAILED DESCRIPTION

Immaterial modifications may be made to the embodiments described here without departing from what is covered by the claims.

Buildings and building systems integrate structural, mechanical, electrical, and environmental components to create safe, functional, and sustainable buildings and building environments. Structural systems ensure the stability and integrity of the building, typically utilizing materials like steel, concrete, or timber to support loads and resist external forces such as wind or seismic activity. Mechanical systems include Heating, Ventilation, and Air Conditioning (HVAC), essential for maintaining thermal comfort and indoor air quality. Electrical systems provide power for lighting, appliances, and communication networks. Plumbing and fire protection systems may ensure the safe delivery of water and effective management of waste, while also safeguarding occupants from fire hazards. Smart building technologies are increasingly integrated, leveraging Internet-of-Things (IoT) devices and automation to optimize energy usage, monitor system performance, and improve overall operational efficiency.

Monitoring and security systems in buildings are used to provide safety, operational efficiency, and asset protection. Monitoring systems may use advanced sensors, cameras, and data analytics to track building performance, environmental conditions, and equipment status. Monitoring systems may often integrate with Building Management Systems (BMS) to provide real-time insights into energy consumption, HVAC performance, lighting levels, and occupancy patterns. Security systems are designed to protect against unauthorized access, theft, and potential threats. Security systems may include access control systems like keycard or biometric authentication, surveillance systems with high-definition cameras and AI-powered analytics for threat detection, and intrusion detection systems with motion sensors and alarms. Advanced solutions often combine monitoring and security functionalities, enabling centralized management through cloud-based or on-premises platforms. Integration with smart technologies, such as IoT devices, enhances functionality, allowing remote access, automated responses, and predictive maintenance capabilities.

The risk of a building fire is one that cannot be ignored in modern building management strategy. Fires in buildings may often result from electrical faults, unattended equipment, flammable materials, or deliberate acts of arson. The behavior of fire within a structure depends on factors such as fuel load, ventilation, building materials, and design. Combustion generates heat, smoke, and toxic gases, which can rapidly compromise visibility and air quality, endangering occupants. The spread of fire is influenced by the integrity of fire barriers, such as walls, floors, and fire-rated doors, as well as the effectiveness of active suppression systems like sprinklers or extinguishers. Modern building codes emphasize fire-resistant materials, compartmentalization, and egress pathways to enhance occupant safety. Early detection through smoke alarms and advanced sensors, combined with automated suppression and robust evacuation strategies, is critical for minimizing fire damage. Computational tools like fire modeling software are increasingly used to predict fire dynamics and assess the effectiveness of fire safety measures during the design phase of buildings.

Fire safety systems are important components of building design and operation. Fire safety systems are engineered to detect, control, and mitigate the risks associated with fire incidents. Fire safety systems may include fire detection systems such as smoke detectors, heat sensors, and flame detectors, which provide early warning of potential fires. Fire suppression systems, such as sprinklers, gaseous suppression agents, and fire extinguishers, may be designed to contain or extinguish fires, preventing their spread. Passive fire protection, including fire-resistant walls, doors, and compartmentalization, may work in tandem with active systems to limit fire propagation and protect structural integrity. Integrated control systems, such as fire alarm control panels, coordinate detection, suppression, and evacuation protocols. Modern fire safety systems may incorporate IoT-enabled devices for real-time monitoring and remote management, enhancing their effectiveness and reliability.

Fire panels, also known commonly as Fire Alarm Control Panels (FACPs), are important components of a building's fire safety system, serving as the central hub for monitoring and managing fire detection and alarm devices. Fire panels connect to smoke detectors, heat detectors, manual call points, sprinkler systems, and other sensors, to detect signs of fire and initiate appropriate responses. Fire panels continuously monitor connected devices for faults or alarms and provide both visual and audible alerts when an issue arises. Key features of modern fire panels include zone-based monitoring, which allows the building to be divided into specific areas for precise alarm identification, and advanced communication protocols that support integration with Building Management Systems (BMS). Fire panels can also display detailed information, such as the exact location of a triggered alarm, and support automatic activation of emergency systems like fire suppression, ventilation shutdowns, or elevator recalls. Fire panels may offer both conventional and addressable configurations, where addressable systems allow individual devices to be uniquely identified for faster diagnostics. Modern fire panels often include remote access capabilities for real-time monitoring and configuration and are typically equipped with battery backups to ensure functionality during power outages.

Modern fire safety systems which incorporate IoT-enabled devices offer advanced capabilities for real-time monitoring, detection, and management of fire risks. These systems may integrate sensors, actuators, and connected devices to provide continuous data on environmental conditions such as temperature, smoke, humidity, and gas concentrations. IoT-enabled detectors can communicate wirelessly with fire alarm control panels and mobile applications, enabling faster and more precise alerts to building occupants and emergency responders. Smart sprinklers and suppression systems can be activated selectively, minimizing water or agent usage while effectively containing the fire. Machine learning algorithms analyze sensor data to predict potential fire hazards, reducing false alarms and improving response times. Integration with Building Management Systems (BMS) may allow fire safety devices to work in harmony with HVAC, lighting, and security systems, enhancing overall safety. Remote monitoring and diagnostics ensure that fire safety systems remain operational, with predictive maintenance features identifying and addressing faults before failures occur.

A fire panel log management system is a specialized software or hardware solution designed to track, store, and analyze the event logs generated by fire panels. A fire panel log management system may capture critical information such as alarm activations, system faults, supervisory conditions, and maintenance activities. By organizing logs in a centralized database, the system may facilitate quick access and detailed analysis of historical data, enabling facility managers to identify recurring issues or trends. Advanced fire panel log management systems often integrate with IoT platforms, allowing remote monitoring and real-time notifications through mobile devices or web dashboards. Some systems may incorporate machine learning algorithms to predict potential failures or optimize maintenance schedules based on historical data

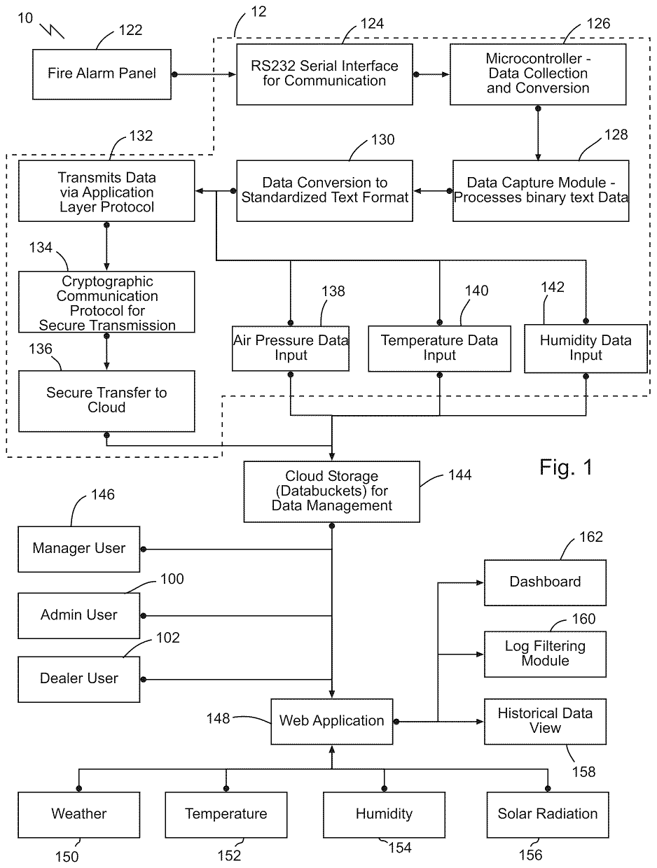

Referring to FIG. 1, a fire panel gateway system 10 is illustrated. The fire panel gateway system 10 comprises a data acquisition module 12. The system architecture may comprise several interrelated components to facilitate seamless data acquisition, transmission, storage and visualization. The data acquisition module 12 may be connectable to receive fire panel data from a fire panel 122. A microcontroller 126 of the data acquisition module 12 may receive fire panel data through a communication interface, for example an RS232 serial interface 124 (or other suitable interface such as USB, RS485, and ethernet interfaces). In one example, the data acquisition module may use a local computing device connected via RS232 interface 124 to capture binary encoded text data directly from the fire panel 122, ensuring reliable and accurate data collection. The microcontroller 126 is responsible for device command and control relating to data acquisition and both fire panel interfacing 124 and network interfacing 38. The microcontroller 126 may convert the binary encoded text data to a standardized text format. For example, microcontroller 126 may be configured to one or more of process the data via a module 128 and convert data to a standardized text format via a module 130. The data acquisition module 12 may have or may be connected to a network interface (such as one performing the functions of modules 132-136 in the example) that is configured to transmit output data from the data acquisition module 12 to a remote computing device via the internet. The output data may comprise time-coded log information from the fire panel data, for external storage of the output data, in association with environmental condition data, in a database. The data acquisition module 12 may be configured to receive and transmit environmental condition data from one or more onboard sensors, for example, air pressure input data via a sensor 138, temperature data input via a sensor 140 and humidity data input via a sensor 142. Environmental condition data may be obtained in a variety of suitable methods, such as via sensors 138, 140, and 142, and integrated into the output data prior to sending. The output data may be securely transferred to the cloud 136.

Referring to FIG. 1, a remote computing device, such as a system 144 for cloud storage and server functions, may be connected to receive the output data through the internet via the network interface. The output data may be transmitted to system 144 via a suitable application layer protocol via a module 132. The references to modules in this document may refer to a physical device in some contexts, such as module 12, and software modules or parts of software that perform various functions in others, such as module 132. The application layer protocol may include a module 134 for a protocol for sending a secure transmission. Referring to FIGS. 1-3, the output data may be stored in a cloud-based storage system. For example, the output data may be stored in a data buckets system 144 storage system. The data buckets system 144 may serve as the centralized repository for storing the transmitted fire panel log data. A cloud platform such as Thinger. io may provide scalable and secure cloud storage solutions, enabling efficient data management and retrieval for subsequent visualization and analysis. The remote computing device (system 144) may have, or may be connected to store the output data, in association with the environmental condition data, in a database. Transmitted data may be securely stored in a database, or example via data buckets (see system 144), which may allow for scalable storage solutions and easy access for authorized users.

Referring to FIG. 1, the system 10 may be configured to permit output data to be accessed by one or more users via a web application 148 or another suitable interface. The web application 148 may access the output data stored in the database to display comprehensive dashboards that include environmental data alongside fire panel logs. Users may access the stored output data using a hierarchical access system. For example, the hierarchical access system may comprise one or more manager user's role 146, one or more admin user's role 100 and one or more dealer users role 102, as will be discussed in further detail below. The web application 148 may access environmental data from external or online sources, for example weather data from a source 150, temperature data from a source 152, humidity data from a source 154, and solar radiation data from a source 156, which may be directly measured using sensors or obtained from third party sources such as a weather network, private, public, or government entity, or an online source. Users may interact with a dashboard 162 to filter and view logs through a log filtering module 160, view historical data module 158, and perform various analytics to analyze trends related to fire safety metrics, and view present and past operation of the fire panel system in general.

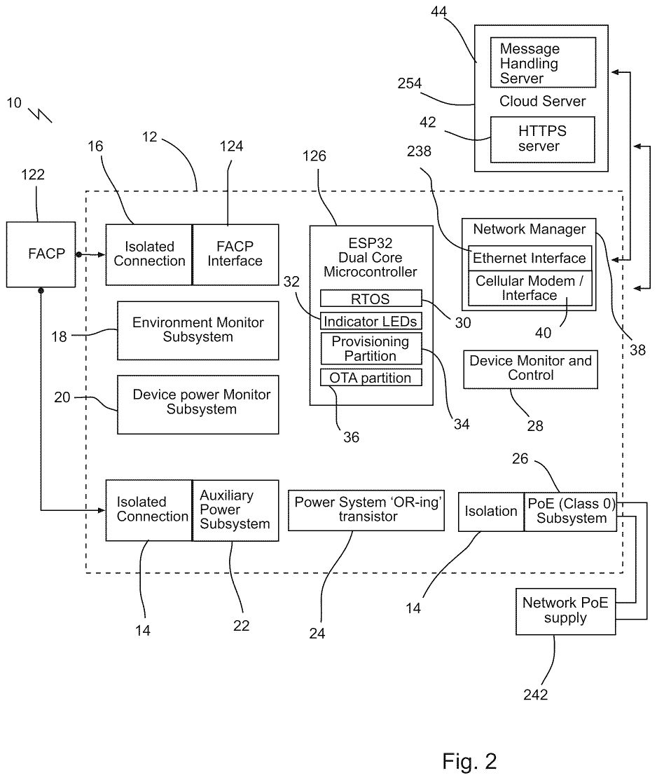

Referring to FIG. 2, an exemplary data acquisition module 12 is disclosed. The data acquisition module 12 may comprise one or more isolated connections 16 to a fire panel 122. The data acquisition module 12 may comprise a fire alarm control panel interface 124, for example interface 124 that links to a printer port of panel 122 via isolated connection 16 or another suitable connection. The data acquisition module 12 may be connected to monitor power use of the fire panel 122, for example via an auxiliary power subsystem 22 connected to panel 122 via isolated connection 14. The module 12 may comprise one or more subsystems, for example an environment monitor subsystem 18, and a Power over Ethernet (PoE) subsystem 26. The environment monitor subsystem 18 may comprise one or more environmental condition sensors, such as sensors for temperature, humidity, pressure, and others. The PoE subsystem 26 may connect to an external network PoE supply 242, allowing the module 12 to be powered by PoE. In other cases, an onboard power supply may be provided, or another type of external power source may be used such as an outlet connector to an AC outlet. The data acquisition module 12 may comprise a Power System ‘OR-ing’ transistor 24. The Power System OR-ing transistor circuit 24 manages redundancy by allowing the module 12 to simultaneously be connected to multiple power sources, such as the fire panels auxiliary power supply connected to the auxiliary power subsystem 22, and PoE power supply connected to the PoE power subsystem. This transistor circuit ensures that only one power supply will ever be used by the device at a time, regardless of whether both or only a single supply is active. In the case that power is provided by the fire panel auxiliary supply, a diode prevents current backflow into the PoE power subcircuit. The data acquisition module 12 may comprise a microcontroller 126, for example an ESP32, or any other suitable microcontroller or local computing device. The microcontroller 126 may comprise one or more of a Real Time Operating System (RTOS) 30, indicator LEDs 32, a provisioning partition 34, and an Over The Air (OTA) partition 36. The data acquisition module 12 may comprise a device monitor and control system 28. The data acquisition module 12 may comprise a network interface such as a network manager 38. The network manager 38 may comprise one or more of an ethernet interface 238 and a cellular modem/interface 40. A cellular modem interface 40 may use a SIM card to send remote communications via a cellular network. The network manager 38 may connect to a cloud server 254 using secure communication protocols. Specifically, the Ethernet interface 238 may utilize Transport Layer Security (TLS) to encrypt data in transit when connecting remotely to a message handling server such as a MQTT broker 44 of the cloud server, ensuring secure message exchange between the data acquisition module 12 and the cloud server. Similarly, the cellular modem/interface 40 may employ HTTPS with TLS encryption to secure data transmission over the cellular network when connecting to an HTTPS server 42 of the cloud server 254. By implementing TLS for messages sent using application layer communication protocols, the data acquisition module 12 ensures that all data exchanged with the cloud server 254 is encrypted and secure, adhering to industry-standard security practices.

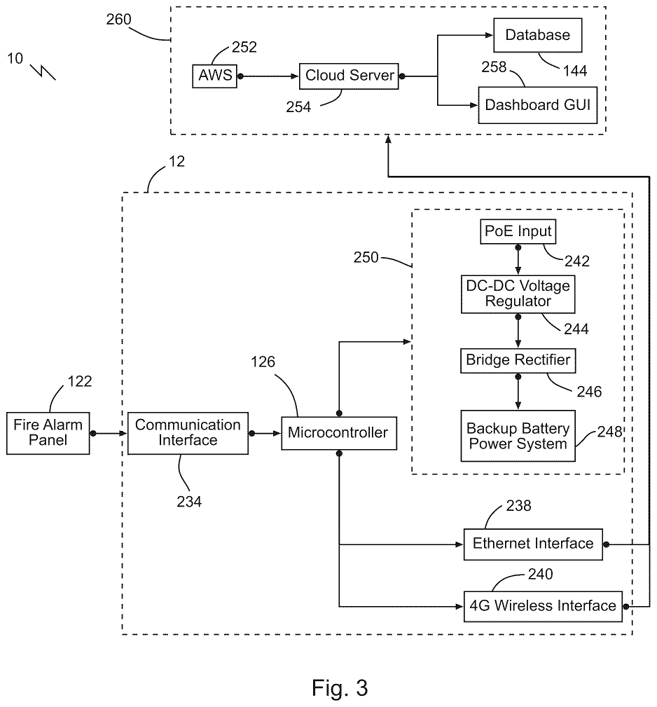

Referring to FIG. 3, the data acquisition module may comprise a suitable local computing device, such as a microcontroller 126. The data acquisition module 12 may comprise a system-on-chip microcontroller 126 that may be configured to establish a physical connection with a communication interface 124 of the fire panel 122. The microcontroller 126 may be configured to connect to a printer port via an RS-232 (Recommended Standard 232) serial communication interface 124 (or other suitable interface such as a USB, RS485, and ethernet interface). The RS-232 serial communication interface 124 may ensure reliable serial communication between the fire panel 122 and the microcontroller 126, facilitating continuous data capture without data loss or corruption. The microcontroller 126 may capture binary encoded text data generated by the fire panel 122, which may include event logs, system statuses, and diagnostic information. The microcontroller 126 may continuously monitor the fire panel's RS232 printer port and capture binary encoded text logs generated by fire safety events. The data acquisition module 12 may be configured to include in the output data for external storage in the database one or more of; fire panel auxiliary voltage, data acquisition module current draw, and data acquisition module power consumption derived from the voltage and current readings. The data acquisition module 12 may comprise a system-on-chip microcontroller 126 that is configured to establish a physical connection with a communication interface of the fire panel. The module 12 may connect microcontroller 126 to panel 122 via an on-board interface 234 for communication with same. The microcontroller 126 may be connected to access one or more ethernet interface 238, or wireless interface 240. The microcontroller 126 may connect to a router via Wi-Fi for remote communication in some cases. A power system 250 may be provided on board, for example with one or more of a backup battery power system 248, a bridge rectifier 246, a DC-DC voltage regulator 244, and a PoE input interface supply 242 (in other cases an AC or DC power system may be used instead of a PoE input supply, such as a DC power supply from the fire alarm control panel).

Fire panels come in a variety of makes and models, each designed to meet specific regulatory standards and operational needs, but they often lack compatibility due to their proprietary nature. Major manufacturers of fire alarm control panels include Honeywell™, Siemens™, Johnson Controls™, Bosch Security Systems™, and Mircom™, among others. Each company offers a range of products, from conventional fire panels that monitor multiple zones to advanced addressable systems that provide detailed information on the status of individual devices. The proprietary protocols and communication standards utilized by these manufacturers mean that components from one brand may not be seamlessly integrated with those from another, complicating system upgrades or expansions and often necessitating the use of dedicated service and replacement parts. This lack of interoperability requires building owners and managers to carefully consider their initial choices of fire panel systems and plan for future needs, as transitioning to a different manufacturer's products may involve significant costs and logistical challenges. Such also makes it difficult and sometimes impossible to switch brands or upgrade parts of a system with parts from a different brand.

Referring to FIGS. 1-3, the data acquisition module 12 may be configured to operate as a universal device. The data acquisition module 12 may be configured to connect to a variety of makes and models of fire panels. The data acquisition module 12 may be configured to receive, process, and transmit output data from a plurality of makes and models of fire panels, allowing integration of the same module 12 into different systems 10 with different branded fire panels. Moreover, the module 12 may be configured to only interact with the fire panel in a receive mode, that is, to only receive data from the fire panel 122 and not to send data or communications to the fire panel 122.

Parsing and processing of signals before retransmission may be an important step in communication systems to ensure data integrity, reliability, and compatibility. Signal parsing involves extracting essential information from the received signal, often by identifying its structure, headers, and payload using predefined protocols. This process may include error detection and correction using techniques like cyclic redundancy checks (CRC) or forward error correction (FEC). Signal processing then prepares the parsed data for retransmission by enhancing its quality, such as through noise reduction, equalization, and modulation format adjustments. Additionally, signal amplification or frequency conversion may be performed to align with the channel characteristics of the retransmission medium. These steps are integral to mitigating degradation, optimizing bandwidth utilization, and ensuring the transmitted signal conforms to the target system's specifications, ultimately enabling efficient communication.

Binary encoded text data, likely in the form of ASCII (American Standard Code for Information Interchange) or UTF-8 (Unicode Transformation Format-8 bit), is what is transferred between the fire panel and the data acquisition device. UTF-8 is the prevalent text encoding format for an overwhelming majority of new devices and is backward compatible with ASCII encoded data. Being agnostic to the particular type of binary encoding allows our device to be capable of understanding both current and legacy fire panel systems.

Referring to FIGS. 1-3, the data acquisition module 12 may be configured to process and transmit output data received from the fire panel 122. The data acquisition module 12 may be configured to capture raw byte data output from the fire panel 122 through the communication interface 124. The data acquisition module 12 may parse the raw byte data according to the fire panel's 122 specific protocol specification. The data acquisition module 12 may convert the parsed data into standardized text format data and include this data within the output data for external storage in the database 232. For example, the data acquisition module 12 may be configured to capture binary encoded text data output from the fire panel 122 through the RS-232 communication interface 124 (or other suitable interface such as a USB, RS485, and ethernet interface), which may be included within the output data. The raw binary encoded text may then be converted into a standardized text format to ensure compatibility with cloud-based data storage and transmission protocols. By utilizing a common type of standardized text format, such as JSON, the system ensures broader support and seamless integration with modern data processing and storage systems.

Environmental condition data refers to measurable parameters that characterize the physical, chemical, and biological state of a given environment. This data typically includes variables such as temperature, humidity, air pressure, wind speed, and precipitation for atmospheric conditions, as well as pH levels, salinity, dissolved oxygen, and pollutant concentrations for water and soil environments. Collected through sensors, satellite observations, or manual sampling, environmental data serves as a foundation for monitoring ecological health, assessing climate change impacts, and guiding resource management. Modern systems often leverage Internet of Things (IoT) devices and advanced analytics to capture, process, and interpret this data in real time. Accurate and reliable environmental condition data is critical for predictive modeling, early warning systems for natural disasters, and compliance with environmental regulations, ensuring informed decision-making and sustainable management of ecosystems.

Environmental condition sensors are specialized devices designed to monitor and measure various physical, chemical, and biological parameters of the environment. Environmental sensors may include temperature sensors, humidity sensors, barometric pressure sensors, and anemometers for atmospheric monitoring; pH meters, turbidity sensors, and conductivity sensors for water quality analysis; and soil moisture and salinity sensors for terrestrial applications. Environmental sensors provide real-time data collection, enabling continuous monitoring and remote access. Advances in sensor technology have improved their sensitivity, accuracy, and energy efficiency, allowing deployment in diverse settings such as agricultural fields, industrial sites, urban areas, and remote ecosystems. Environmental condition sensors may be used in climate studies, pollution tracking, disaster prediction, and sustainable resource management, to allow for data-driven decisions.

Environmental conditions may play a role in the performance and reliability of fire panels and the devices they monitor. Factors such as temperature, humidity, dust, and air quality can affect the sensitivity and accuracy of fire detection systems. For example, high humidity or condensation can cause false alarms in smoke detectors, while excessive dust accumulation may obstruct sensors, reducing their effectiveness. Extreme temperatures may impair the functionality of fire panels and connected devices, with components such as batteries and circuitry being particularly susceptible to failure outside of their specified operating ranges. Solar radiation may play a role in the operation and longevity of a fire panel. To address these and other challenges, fire panels and their associated systems may in the future be designed with environmental tolerances in mind, incorporating features like environmental compensation algorithms. These algorithms may adjust sensor thresholds dynamically to minimize false alarms caused by ambient conditions. Additionally, enclosures with IP-rated protection are used to shield fire panels from harsh environmental factors, such as moisture or particulates. In specialized environments—like industrial facilities or data centers—fire panels may also integrate with additional environmental monitoring systems to account for variables like airflow, gas presence, or rapid temperature changes, ensuring optimal performance and compliance with safety standards.

Referring to FIG. 1, the fire panel gateway system 10 may be configured to incorporate environmental condition data into the output data that is sent off site to the remote computing device. The data acquisition module 12 may have or may be connected to one or more sensors that are configured to record at least a portion of the environmental condition data. For example, the one or more sensors may include one or more of a weather data input sensor 138, temperature data input sensor 140, and humidity data input sensor 142. The data acquisition module 12 may be configured to include, within the output data, the local environmental condition data from one or more sensors. The one or more sensors and the network interface may be integrated on board the data acquisition module 12. In other cases, one or more of the sensors may be off board, for example connected to provide environmental condition data directly to the module 12 or indirectly via other components or protocols. The environmental condition data that is measured by the one or more sensors may comprise one or more of: weather conditions, air pressure, interior temperature, exterior temperature, humidity, and solar radiation activity. The data obtained from one or more of the weather data input sensor 138, temperature data input sensor 140, and the humidity data input sensor 142 may be transmitted to and stored in the data buckets system 144. In some embodiments, the system may use local temperature, humidity and air pressure at the device, along with fire panel auxiliary voltage.

Referring to FIG. 1, the fire panel gateway system 10 may incorporate environmental condition data from third party sources. The remote computing device may be configured to obtain at least a portion of the environmental condition data from one or more third party sources. For example, the remote computing device may obtain one or more of: weather data from a source 150, temperature data from a source 152, humidity data from a source 154, and solar radiation data from a source 156, one or more of which are third party sources. The remote computing device may be configured to obtain at least the portion of the environmental condition data from one or more third party sources via an application programming interface (API). The remote computing device may be configured to obtain at least the portion of the environmental condition data via the application programming interface (API) by automatically polling the API at periodic intervals.

Solar radiation data may be obtained from a third-party source. NASA's (National Aeronautics and Space Administration) Solar Activity page, hosted on the Community Coordinated Modeling Center (CCMC) website, is one such source and provides a robust toolset for monitoring and analyzing solar events via its DONKI (Database of Notifications, Knowledge, and Information) web services. The DONKI system aggregates and disseminates critical space weather data, including solar flares, coronal mass ejections (CMEs), solar energetic particles (SEPs), and geomagnetic activity. This platform is particularly valuable for researchers and operational forecasters, as it offers programmatic access to event data through RESTful APIs, enabling the integration of real-time and historical solar activity information into custom applications. Each event is cataloged with detailed parameters such as onset times, locations, and potential Earth impacts, ensuring high utility for predictive modeling and mitigation strategies. The system's open-access architecture promotes collaboration within the scientific community, aiding efforts to understand and predict solar-terrestrial interactions. The system can provide GPS data to associate solar activity information with specific geographic locations, such as the site of a fire panel 122, enhancing the relevance and utility of the data for predictive modeling and mitigation strategies.

Solar activity encompasses a variety of dynamic phenomena that originate from the Sun and influence the space environment. High-Speed Streams (HSS) are fast-moving flows of solar wind originating from coronal holes, capable of interacting with Earth's magnetosphere to enhance geomagnetic activity. Radiation Belt Enhancements occur when charged particles from the solar wind or solar energetic particles increase the intensity of Earth's Van Allen radiation belts, potentially impacting satellite operations. Magnetopause Crossings occur when the boundary of Earth's magnetosphere is pushed inward by solar wind pressure or interplanetary shocks, exposing spacecraft to the solar wind. Solar Energetic Particles (SEPs) are high-energy charged particles released during solar flares or coronal mass ejections (CMEs) that pose a radiation hazard to astronauts and technology. Solar Flares are sudden, intense bursts of electromagnetic radiation from the Sun's surface, often associated with increased X-ray and radio emissions. Interplanetary Shocks are abrupt changes in the solar wind's speed, density, and magnetic field, frequently caused by fast CMEs overtaking slower solar wind streams. Geomagnetic Storms are disturbances in Earth's magnetosphere driven by solar wind or CMEs, leading to auroras, disruptions in communications, and power systems. Coronal Mass Ejections are large-scale ejections of plasma and magnetic fields from the Sun's corona, often driving severe space weather events when directed toward Earth. These solar activities collectively shape the space weather environment and are crucial for understanding Sun-Earth interactions.

Solar events such as Solar Energetic Particles (SEPs), Geomagnetic Storms, Coronal Mass Ejections (CMEs), and Solar Flares may impact fire panel operations and other critical infrastructure systems by disrupting electronic components and communication networks. Fire panels, which rely on electronic circuits and sensors for accurate detection and communication of fire hazards, are vulnerable to electromagnetic interference caused by these solar events. For example, geomagnetic storms can induce currents in power lines, potentially leading to voltage fluctuations or outages that affect fire panels'power supply. High-energy particles from SEPs or CMEs can cause single-event upsets (SEUs) in microprocessors, leading to false alarms or system malfunctions. Solar flares pose additional risks by producing intense bursts of electromagnetic radiation, including X-rays and ultraviolet light, which can further disrupt communication signals and result in false alarms or system failures. The increased ionization in the Earth's atmosphere during a solar flare can complicate the reliability of wireless communication systems integral to modern fire detection and alarm systems. Additionally, the intense radiation from solar flares can damage sensitive electronic components, impacting the performance of fire panels. Referring to FIG. 1, solar radiation activity data from source 156 may comprise one or more of coronal mass ejection, geomagnetic storm, and solar flare information specific to the location of the data acquisition module or fire panel. Such information may be stored in a cloud database along with the output data, in order to attempt to correlate such data with operation of the fire panel 122.

Referring to FIGS. 1-3, the network interface may be configured to communicate the output data via a suitable higher-level application layer. For example, the network interface may be configured to communicate the output data via an application layer communication protocol such as MQTT (Message Queuing Telemetry Transport). The network interface may utilize this application layer communication protocol to transmit the standardized text format data to the data buckets system 144. MQTT may be chosen as the primarily used application layer communication protocol for its lightweight, efficient, and reliable message-oriented communication, which is ideal for real-time data transmission in IoT applications.

Web application interfaces serve as the touchpoint between users and the underlying functionality of an online software application, enabling interaction and user experience. Web application interfaces are typically composed of two main layers: the front-end and the back end. The front-end is responsible for rendering the user interface (UI), providing visual elements like buttons, forms, and navigation menus that facilitate user engagement. On the other hand, the back-end handles server-side logic, database interactions, and application programming interfaces (APIs) that process requests from the front-end. APIs enable communication between different software components, allowing for data retrieval and manipulation while ensuring secure and efficient data exchange through architectural styles like REST (Representational State Transfer) or query languages like GraphQL. Together, these layers create a cohesive web application interface that enhances usability, accessibility, and performance, ultimately contributing to a positive user experience.

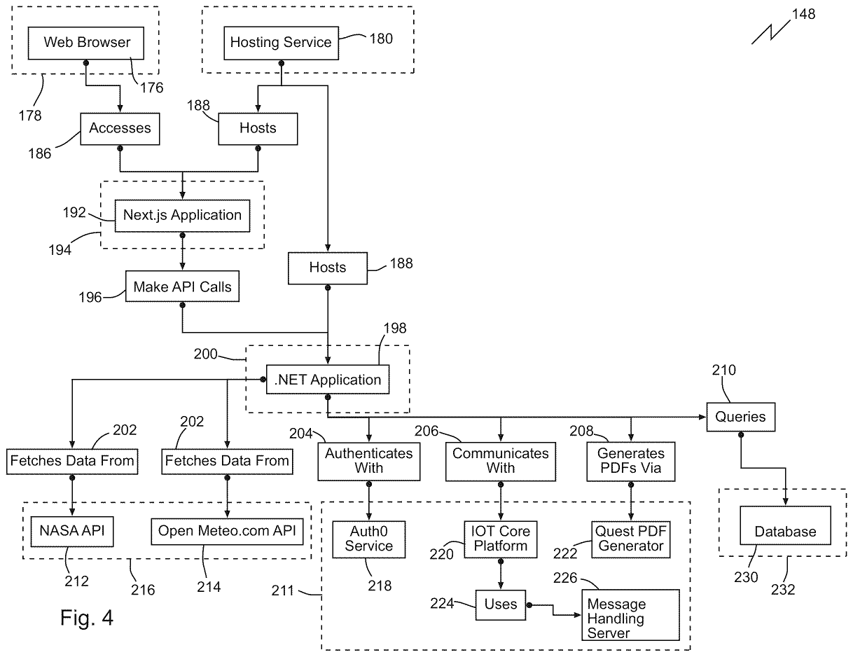

Referring to FIGS. 1 and 4, the remote computing device may be configured to operate a web application 148. The remote computing device may be configured to serve instructions to load an application interface, such as the web application 148, on a remote computer or mobile device. The application interface may be configured to display at least part of the data from the database, such as database 232 (system 144). The web application 148 may access the stored data to display a comprehensive dashboard 162 which may include environmental data alongside fire panel logs. Users may interact with the dashboard 162, for example to filter logs via a log filtering module 160, view historical data via module 158, and analyze trends related to fire safety metrics. The dashboard 162 may present real-time and historical data through an intuitive interface. The dashboard may display comprehensive information, including device statuses, environmental conditions (weather, temperature, humidity, solar radiation and others), and detailed fire panel logs. The historical data module 158 may allow users to access and review archived logs, supporting trend analysis, incident investigations, and long-term fire safety management strategies. The log filtering module 160 may allow users to filter and search logs based on specific time ranges and keywords, facilitating targeted data analysis and swift retrieval of pertinent information.

Referring to FIG. 4, the structure of an example web application 148 is illustrated. A client operating a computing device 178, such as a mobile phone, tablet, or personal computer, may operate a web browser application on device 178 to access via a module 186 a frontend system 194 for displaying a web application interface. An infrastructure of the web application 148 may operate using a hosting service 180, such as one that operates via docker containers. A container is a standard unit of software that packages up code and all its dependencies so the application runs quickly and reliably from one computing environment to another. A Docker container image is a lightweight, standalone, executable package of software that includes everything needed to run an application: code, runtime, system tools, system libraries and settings. The hosting service 180 may host, via a module 188, the frontend system 194 and a backend system 200. The user may communicate with the system via the front-end system 194, and the backend system 200 may interpret such commands and respond accordingly. The frontend system 194 may operate on the user's device 178, for example running a script or code supported by the browser, for example running a Next. js application module 192. The Next.js application module may convert the user's instructions to make API calls via a module 196 which feeds into the backend system 200. The Docker containers may encapsulate the backend system 200, ensuring that the application code runs in a consistent and isolated environment. The backend system 200 may operate a suitable platform, such as a . NET application module 198. The .NET application module 198 may respond to instructions from the user to initiate one or more queries, via a module 210, of a database 232, which may be any suitable database such as a PostgreSQL™ database 230. The .NET application module 198 may also communicate with one or more third party information sources, to fetch data, such as environmental condition data, via a module 202, from one or more external sources 216, such as one or more of NASA API 212 and open Meteo.com API 214. The .NET application module 198 may associate third party environmental condition data with data from the data acquisition module 12. Data in a cloud database 232 may integrate data from such third-party sources via date-stamped entries, so that a user may view data from a fire panel at any given time period past or present, alongside relevant environmental condition data from third parties. The . NET application module 198 may access various other services 211 for operation, for example module 198 may authenticate users, data, and devices via a module 204 that communicates with an Auth0 service 218. The .NET application module 198 may communicate with a variety of devices, such as sensors, via a communication module 206, to an IoT core platform module 220, which may perform a variety of uses via other modules 224. The IoT core platform module 220 may use module 224 to access a message handling server such as an MQTT broker 226 for various related functions. Data to and from the message handling server 226 may be managed and routed through the backend system 200, ensuring efficient and secure communication. The . NET application module 198 may generate portable document files (PDFs) via a module 208 that accesses a quest PDF generator 222.

Hierarchical access to data is a structured approach that organizes information in a tree-like model, where each piece of data, or node, has a parent-child relationship. This model allows for the efficient retrieval and management of data by establishing clear relationships and access levels based on a predefined hierarchy. In practice, hierarchical data structures can be implemented using various technologies, such as XML, JSON, or database management systems that support nested tables or tree-like structures. For example, in a database, a hierarchical model can be represented using foreign key relationships, where a parent entity contains one or more child entities, enabling cascading operations like updates or deletions. This method of data access enhances security and control, as permissions can be assigned at different levels of the hierarchy, allowing users to access only the data they are authorized to view or manipulate. Hierarchical access improves data organization and facilitates navigation, making it easier for users to traverse complex data sets and extract meaningful insights while maintaining data integrity and consistency.

Referring to FIGS. 1 and 4, the web application 148 interface may be configured to allow customizability to manage user administration and provide different users different privileges and scope to access and filter data from the database. Authorized users may access the web application 148 to view and interact with the stored data. The web application 148 may comprise advanced visualization tools, including interactive dashboards, graphical trend analysis, and customizable log filtering, which may enhance user engagement and decision-making. The web application 148 may be configured to include or access a filtering system that allows users to filter the data from the database by time range and keywords.

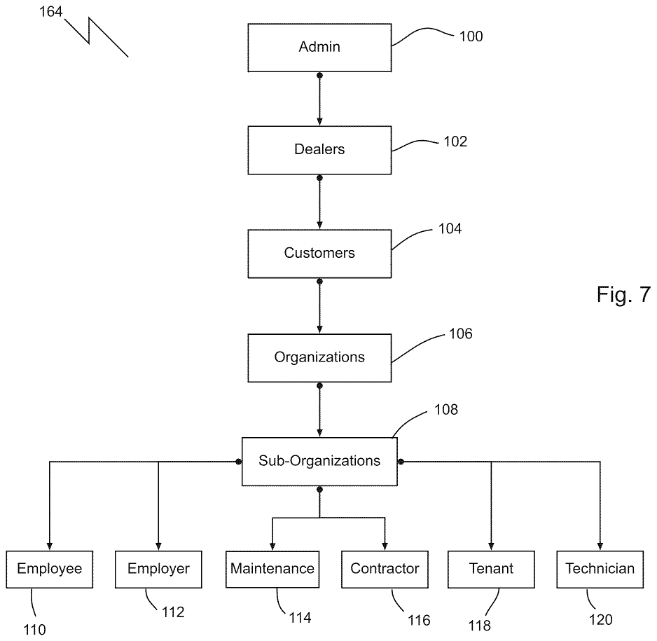

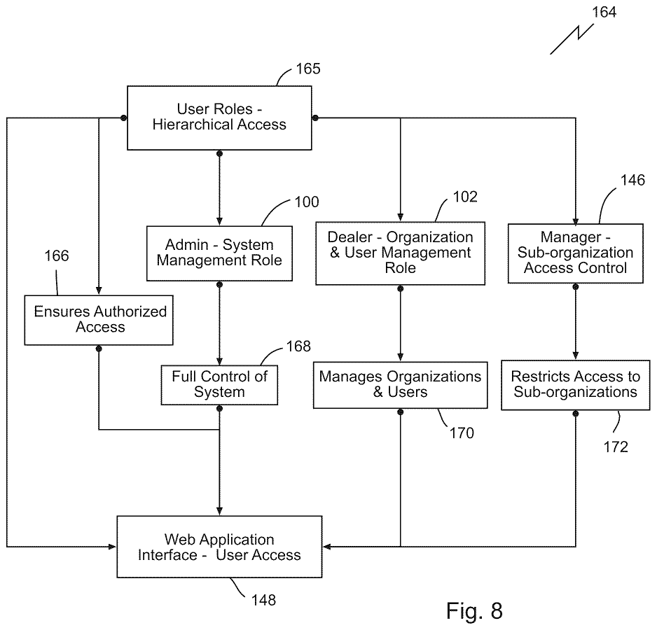

Referring to FIGS. 7 and 8, an example hierarchical structure of access is illustrated. The remote computing device that operates the backend system 200 may be configured to incorporate a hierarchical user access control methodology 164. The hierarchical user access control methodology 164 may restrict user access to different functionalities and data from the database based on user roles. The web application 148 may control and administer user access via one or more suitable modules, such as a user role access module 165. The user roles adopted may comprise one or more of an administrator role 100, a dealer role 102 and a manager role 146. Various other roles may be introduced. The administrator role 100 may have the highest level of delegation and access, for example an administrator may manage organizations 106 and dealers 102, for example, the administrator role 100 may be authorized to add and manage organizations 106 and dealers 102 and oversee the broader system configuration and user base. The dealer role 102 may manage sub-organizations 108 and users, such as customers 104. For example, the dealer role 102 may be permitted to add main users (customers 104), organizations 106, and sub-organizations 108, and facilitate the distribution of responsibilities and data management within their designated domains. Suborganizations may include one or more of employees 110, employer 112, maintenance workers 114, contractors 116, tenants 118 and technicians 120. The manager role 146 may manage building-level access for technicians 120, for example, the manager role 146 may be responsible for assigning and managing users within specific sub-organizations 108, and restricting access to logs and data pertinent exclusively to their assigned buildings or facilities. The hierarchical user access control methodology 164 may ensure secure and organized data access. A cloud-based architecture of the system 10 may allow for scalable data storage and flexible user management, accommodating organizational growth and evolving fire safety requirements. Referring to FIG. 8, the structure of an example hierarchical user access control methodology 164 is illustrated. The hierarchical user access control methodology 164 ensures authorized access 166 to the web application 148 interface. The admin role 100 may have full control 168 of the system 10. The dealer role 102 may manage organizations and users 170. The manager role 146 may restrict access 172 to sub-organizations. The example shown provides a web application 148 interface that may be configured to display data from the database, in a multi-tenant architecture form, to enable a plurality of organizations to access data from the database, comprising fire panel logs and environmental condition data, independently while sharing the same underlying infrastructure, and where each organization has independent control over user access within their domain.

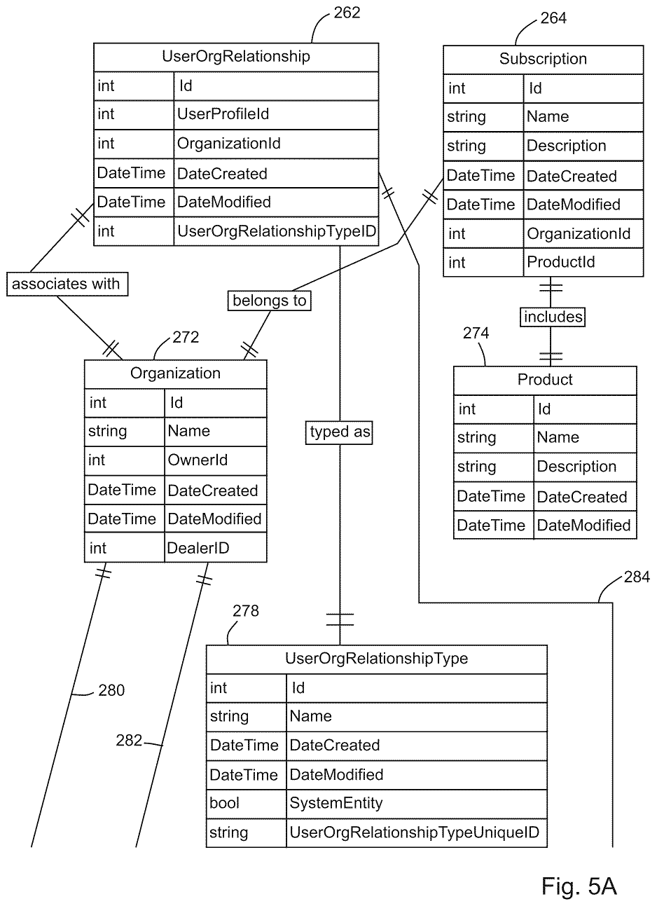

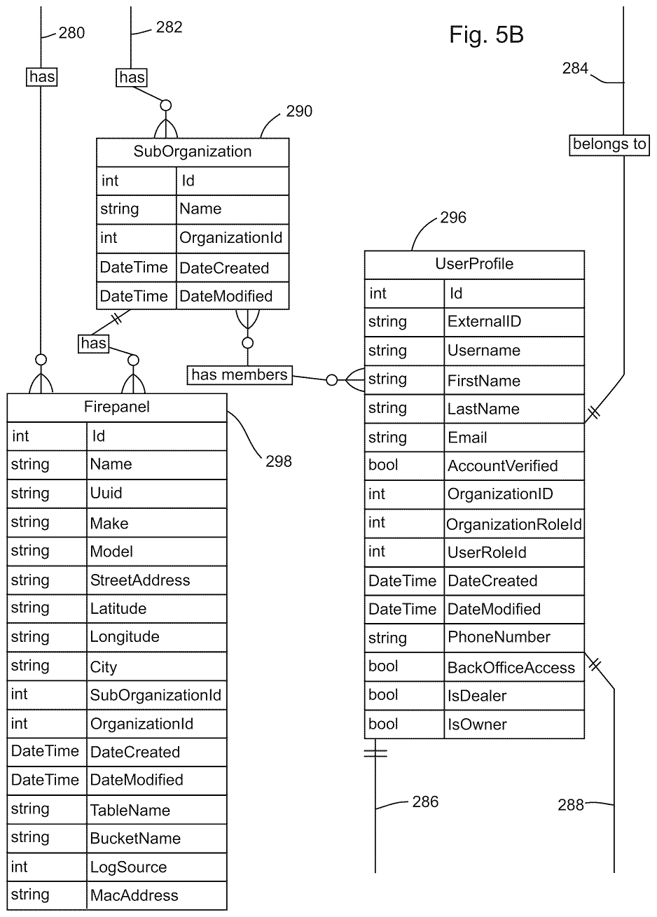

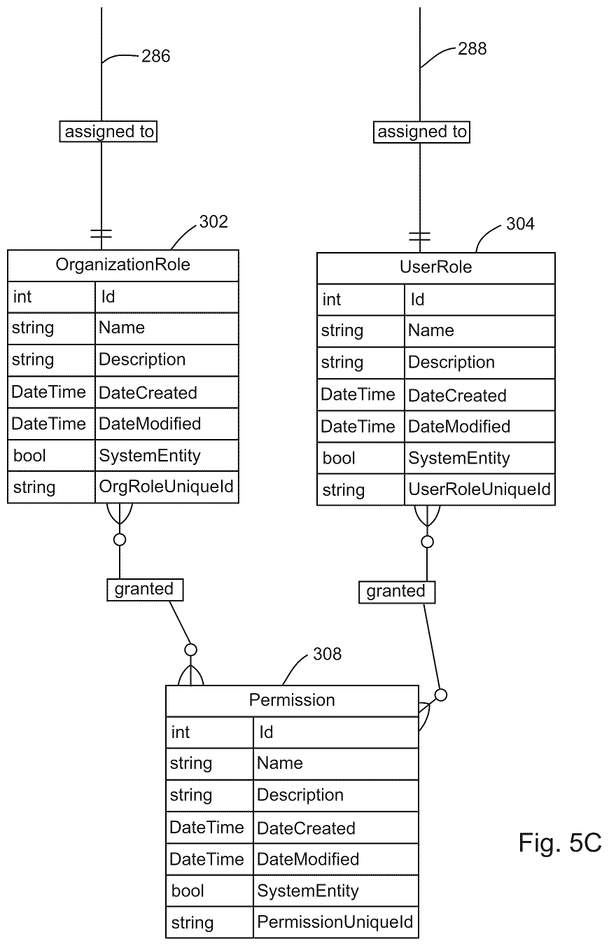

Referring to FIGS. 5A-5C, an example table structure for a database of users is illustrated. A user, such as a dealer, may have its information stored in a table 262. The table 262 may be associated with an organization table 272. A subscription table 264 may be used in conjunction with the organization table 272 to administrate organization privileges. Table 264 may be associated with various other tables, such as a product table 274. User table 262 may be associated with a user relationship table 278. Table 272 may associate, via relationship 280, with a fire panel table 298. Table 272 may also be associated via relationship 282 to sub organization table 290, which includes information on sub-organizations, such as groups within an organization, such as engineering or maintenance. Table 290 may be associated with fire panel table 298 as well. User table 262 may associate, via relationship 284, to a user profile table 296. User profile table 296 may associate, via relationships 286 and 288 to organization role table 302 and user role table 304, respectively. Permission table 308 may be used to keep a log of permissions granted, via tables 302 and 304.

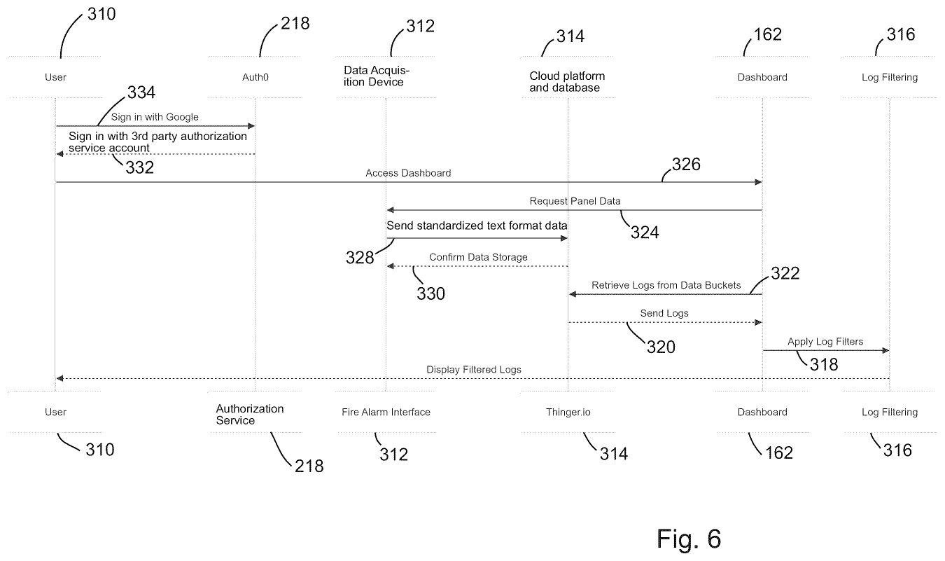

Referring to FIG. 6, an example flow of access and privilege is illustrated. A user 310 may access the web application interface via a sign in on a browser in 334. An authentication token 332 provided by an authorization module such as Auth0 service 218 may allow the user access to a variety of aspects of the system, including a fire alarm interface 312, for example via an access dashboard 326. A user 310 may use interface 312 to request fire panel data 324. The dashboard 162 may respond accordingly. The interface 312 may also cooperate to send parsed data in 328. Data storage may be confirmed in 330. A cloud IoT Platform may be provided, such as Thinger.io 314, to provide every needed tool to prototype, scale and manage connected products in a very simple way. Its goal is to democratize the use of IoT, making it accessible to the whole world, and streamlining the development of big IoT projects. Dashboard 162 may retrieve logs from the database in 322 and may send logs to the database in 320. Log filtering 316 may be carried out, for example in response to filtering queries by user 310, via one or more filters 318. Example filters include date ranges, time ranges, fire panel types, locations, buildings, sections of buildings, responsible employees, users, alert types, alert frequency, alert variables in general, and any type of data stored including weather, solar, humidity, and other factors.

Fire panel gateways often face several shortcomings that can limit their effectiveness. A significant limitation is the lack of real-time data transmission and alerts, which may delay critical response actions during emergencies. Many fire panel gateways are designed to relay only basic event information to local control panels, without leveraging advanced communication technologies for immediate remote notifications. Another drawback is the inability to extract and analyze long-term trends from event logs. This prevents facility managers from gaining insights into recurring system issues, false alarms, or maintenance needs, which could improve system reliability and efficiency. Furthermore, some gateways lack interoperability with IoT platforms or Building Management Systems (BMS), restricting integration with broader safety and operational infrastructure.

Referring to FIGS. 1-8, there are many potential applications for the fire panel gateway system 10. The system 10 may be used in commercial enterprises, for example, the system 10 may be used to facilitate centralized fire safety monitoring across multiple office buildings, ensuring consistent data management and rapid incident response. The system 10 may be used in industrial facilities, for example, the system 10 may be used to manage complex fire safety systems within large industrial plants, integrating environmental data for enhanced safety protocols. The system 10 may be used in residential complexes, for example, the system 10 may be used to oversee fire safety across various residential units, with restricted access ensuring data security and privacy. The system 10 may be used in educational institutions, for example, the system 10 may be used to administer fire safety data across campuses, supporting comprehensive safety management and regulatory compliance. The system 10 may be used in healthcare facilities, for example, the system 10 may be used to ensure fire safety monitoring in hospitals and clinics, integrating environmental conditions to safeguard critical infrastructure and patient safety. The system 10 may combine fire panel logs with environmental data in order to provide a holistic view of fire safety conditions.

The ability to receive real-time alerts from a fire panel provides critical advantages for fire safety and emergency response.. They enable immediate detection and notification of fire incidents, reducing response times and minimizing potential damage. Real-time alerts ensure that key stakeholders, including emergency services, building occupants, and facility managers, are promptly informed through various communication channels such as text messages, emails, or alarms. This proactive approach enhances situational awareness, allowing for swift evacuation and targeted firefighting efforts. Additionally, real-time data from the fire panel can be integrated with building management systems, enabling automated safety protocols such as unlocking doors, shutting down HVAC systems, and activating fire suppression systems, thereby enhancing overall safety and operational efficiency. In some cases, the fire panel gateway system 10 may be configured to provide real-time alerts. The remote computing device may be configured to operate a real-time alert system module, which may send notifications to users based on predefined events from the data from the database. Access to particular alerts may depend on hierarchical position, for example, a particular alert may be sent to a technician, for example if the panel was malfunctioning and required repair. Other types of alerts may be sent to more than one group of users, or higher-level users. For example, a fire detection alert may be sent to employees and employers. A user at the sub-organization 108 level may set which users get which alerts, to ensure a rapid and timely response to issues detected by the fire panel.

Machine learning, a subset of artificial intelligence (AI), involves developing algorithms that enable systems to learn from and act on data without explicit programming for each task. Within the context of fire panel log management, machine learning algorithms analyze large volumes of sequential data, such as fire panel logs and environmental metrics, to identify patterns, detect anomalies, and predict potential system failures or risks. Supervised learning models can be trained on labeled historical data to classify log events or forecast trends, while unsupervised learning methods can uncover hidden patterns or clusters in logs, such as recurring anomalies. Reinforcement learning may also be applied to optimize decision-making processes in dynamic environments. Commonly used techniques like neural networks, decision trees, and ensemble methods ensure robust data analysis and predictive capabilities. By integrating machine learning, the system enhances fire safety management with real-time insights, trend analysis, and proactive maintenance scheduling, driving operational efficiency and system reliability.

Machine learning techniques applied to time series data collected through device polling facilitate advanced trend analysis and predictive modeling. Sequential data from fire panel logs, combined with environmental metrics such as temperature and humidity, are processed to extract meaningful patterns, identify anomalies, and forecast potential issues. Modern algorithms, including recurrent neural networks (RNNs), long short-term memory (LSTM) networks, and gradient boosting models, analyze complex temporal dependencies, offering superior insights over traditional statistical methods. These models are enhanced by feature engineering techniques, which derive lagged values, rolling averages, and other time-based indicators to improve accuracy. This approach supports predictive maintenance, anomaly detection, and operational optimization, ensuring enhanced safety and resource management in fire panel systems.

Maintenance of fire panels is essential to ensure reliable operation and compliance with safety standards. Regular inspections and testing are mandated by fire safety regulations, typically conducted on a semi-annual or annual basis, depending on local codes. These procedures involve checking the functionality of the fire panel itself, including the control unit, alarms, and communication interfaces. Technicians perform visual inspections to identify signs of physical damage, corrosion, or wear, and test all connected devices—such as smoke detectors, heat detectors, and manual pull stations—for proper operation and responsiveness. Battery backups may also be tested to confirm they maintain adequate charge and capacity, ensuring the system remains operational during power outages. Additionally, software and firmware updates may be used for maintaining cybersecurity and enhancing system functionality.

Referring to FIGS. 1-8, the remote computing device may be configured to operate a machine learning module to analyze and derive trends that may be used to improve fire panel systems. The machine learning module may analyze data from the database over time to predict potential fire safety risks based on historical patterns and environmental conditions. The machine learning module may extract trends and develop more reliable and accurate repair and replacement schedules. The machine learning module may develop the repair and replacement schedules based on general trends among all fire panels 122 and specific trends based on information and readings from a specific fire panel 122. The system disclosed here, particularly one that collects and stores data from numerous fire panels of numerous clients and organizations, will over time collect a valuable body of data that may be mined for knowledge and relationships that may be used for better fire panel performance in the future. For example, there may be a connection between output of a fire panel, such as power use polling, and likelihood of near-future failure. Polling a large data set for relevant factors may reveal important relationships. In addition, there may be correlations or causations between solar activity and fire panel reliability or longevity, and polling a large data set for the same may reveal such a relationship.

Referring to FIG. 1, the system 10 may be configured to generate reports for the user. The remote computing device, such as system 144, may comprise a report-generation module, implemented for example as one or more software processes executed by a processor of the remote computing device and stored in a non-transitory computer-readable memory. The device may be configured to receive output data comprising device-level operational, diagnostic, and event data transmitted by the field interface device (data acquisition module) from the fire alarm system, the output data including for example time-stamped status messages, sensor measurements, fault codes, alarm activation records, supervisory condition indicators, device identifiers, loop or zone identifiers, and configuration parameters, and being transmitted over a wired or wireless communication interface using a defined protocol. The report-generation module may be configured to automatically parse, classify, and map the output data to corresponding inspection and testing requirements defined in standards, such as national fire-alarm reporting standards, by applying rule sets, lookup tables, or data schemas that associate particular device types, events, and conditions with specific inspection, test, or reporting obligations. Various such standards include but are not limited to NFPA 72, CAN/ULC-S536 and CAN/ULC-S537. National fire alarm inspection, testing, maintenance, and reporting practices are governed by standardized codes and standards that define minimum performance, verification, and documentation requirements for fire detection and alarm systems. In the United States, NFPA 72 (the National Fire Alarm and Signaling Code) specifies functional requirements for system design, installation, operation, inspection, testing, maintenance, performance verification, and documentation of fire alarm and emergency communication systems, including requirements relating to device operability, signal transmission, power supply integrity, supervisory functions, fault detection, and record keeping. In Canada, CAN/ULC-S536 establishes requirements and procedures for the inspection and testing of fire alarm systems, including prescribed inspection intervals, test methods, verification of system components, and mandatory documentation of system status and deficiencies, while CAN/ULC-S537 establishes requirements for the verification of fire alarm systems, including acceptance testing procedures, functional performance criteria, and verification documentation at the time of system commissioning or modification. Collectively, these standards define structured technical requirements for confirming operational readiness of fire alarm systems, detecting and documenting faults or impairments, and producing standardized inspection, testing, and verification records suitable for submission to building owners, authorities having jurisdiction, and service providers.

The report-generation module may be configured to carry out other steps. The module may populate standardized inspection and testing forms mandated by the applicable national fire-alarm reporting standard, including required fields relating to device functionality, emergency power performance, wiring integrity, communication pathways, system supervisory conditions, and overall system operation, including for example battery capacity and load test results, primary and secondary power source status, circuit continuity and resistance values, end-of-line device presence, communication signal integrity, alarm transmission verification, trouble and supervisory signal verification, and confirmation of required periodic tests having been performed. The module may be configured to generate a compliant inspection or testing report in a structured electronic format suitable for submission to building owners, authorities having jurisdiction, or service providers, the structured electronic format including for example a machine-readable data file, a digitally signed document, or a formatted electronic form with embedded metadata and audit information. The module may be configured to ensure that the completed report adheres to the specific formatting, terminology, content requirements, and record-keeping provisions defined by the relevant NFPA, UL and ULC standard (including any mandated appendices, checklists, or prescribed report forms), for example including requirements relating to report retention, version control, traceability of source data, identification of the testing entity, and authentication of the report contents.

In the claims, the word “comprising” is used in its inclusive sense and does not

exclude other elements being present. The indefinite articles “a” and “an” before a claim feature do not exclude more than one of the feature being present. Each one of the individual features described here may be used in one or more embodiments and is not, by virtue only of being described here, to be construed as essential to all embodiments as defined by the claims.

1. A fire panel gateway system comprising:
a data acquisition module that:
is connectable to receive fire panel data from a fire panel; and
has or is connectable to a network interface that is configured to transmit output data from the data acquisition module to a remote computing device via the internet, the output data comprising time-coded log information from the fire panel data, for external storage of the output data, in association with environmental condition data, in a database.

2. The fire panel gateway system of claim 1 further comprising the remote computing device connected to receive the output data through the internet via the network interface; and in which the remote computing device has, or is connected to store the output data, in association with environmental condition data, in the database.

3. The fire panel gateway system of claim 1 in which the remote computing device is configured to obtain at least a portion of the environmental condition data from one or more third party sources.

4. The fire panel gateway system of claim 3 in which the remote computing device is configured to obtain at least the portion of the environmental condition data from one or more third party sources via an application programming interface (API).

5. The fire panel gateway system of claim 4 in which the remote computing device is configured to obtain at least the portion of the environmental condition data via the application programming interface (API) by automatically polling the API at periodic intervals.

6. The fire panel gateway system of claim 1 in which the remote computing device is configured to serve instructions to load an application interface on a remote computer or mobile device, the application interface configured to display at least part of the data from the database.

7. The fire panel gateway system of claim 6 in which the application interface is configured to include or access a filtering system that allows users to filter the data from the database by time range and keywords.

8. The fire panel gateway system of claim 6 in which the remote computing device is configured to incorporate a hierarchical user access control methodology that restricts user access to different functionalities and data from the database based on user roles.

9. The fire panel gateway system of claim 8 in which the user roles comprise one or more of:
an administrator role to manage organizations and dealers;
a dealer role to manage sub-organizations and users; and
a manager role to manage building-level access for technicians.

10. The fire panel gateway system of claim 6 in which the application interface is configured to display data from the database in a multi-tenant architecture form, to enable a plurality of organizations to access data from the database, comprising fire panel logs and environmental condition data, independently while sharing the same underlying infrastructure, and where each organization has independent control over user access within their domain.

11. The fire panel gateway system of claim 1 in which the remote computing device is configured to operate a real-time alert system module, which sends notifications to users based on predefined events from the data from the database.

12. The fire panel gateway system of claim 1 in which the remote computing device is configured to operate a machine learning module that analyzes the data from the database over time to predict potential fire safety risks based on historical patterns and environmental conditions.

13. The fire panel gateway system of claim 1 in which:
the data acquisition module has or is connected to one or more sensors that are configured to record at least a portion of the environmental condition data; and
the data acquisition module is configured to include, within the output data, the environmental condition data from the one or more sensors.

14. The fire panel gateway system of claim 13 in which the one or more sensors and the network interface are integrated on board the data acquisition module.

15. The fire panel gateway system of claim 1 in which the environmental condition data comprises one or more of weather conditions, air pressure, interior temperature, exterior temperature, humidity, and solar radiation activity.

16. The fire panel gateway system of claim 15 in which the solar radiation activity comprises one or more of coronal mass ejection, geomagnetic storm, and solar flare information specific to the location of the data acquisition module or fire panel.

17. The fire panel gateway system of claim 1 in which the data acquisition module is configured to include in the output data, for external storage in the database, of one or more of fire panel auxiliary voltage, fire panel auxiliary current, and data acquisition module power consumption.

18. The fire panel gateway system of claim 1 in which the data acquisition module comprises a system-on-chip microcontroller that is configured to establish a physical connection with a communication interface of the fire panel.

19. The fire panel gateway system of claim 18 in which the data acquisition module is configured to:
capture binary encoded text data output from the fire panel through the communication interface;
parse the gathered binary encoded text data according to the fire panel's specific protocol specification;
convert the parsed data into standardized text format data; and
include the standardized text format data within the output data for external storage in the database.

20. The fire panel gateway system of claim 1 in which the data acquisition module is configured to operate as a universal device that is configured to connect to a variety of makes and models of fire panels.

21. The fire panel gateway system of claim 1 in which the network interface is configured to communicate the output data via a higher-level application layer.

22. The fire panel gateway system of claim 1 in which the remote computing device further comprises a report-generation module configured to:
automatically parse, classify, and map the output data to corresponding inspection and testing requirements defined in national fire-alarm reporting standards;
populate standardized inspection and testing forms mandated by the applicable national fire-alarm reporting standard, including required fields relating to device functionality, emergency power performance, wiring integrity, communication pathways, system supervisory conditions, and overall system operation; and
generate a compliant inspection or testing report in a structured electronic format suitable for submission to building owners, authorities having jurisdiction, or service providers.

23. A method comprising using the fire panel gateway system of claim 1 to receive and store output data from the fire panel in the database.

24. The method of claim 22 comprising serving output data from the database to a remote device of a user.
